(19) United States
(12) Patent Application Publication
(10) Pub. No.: US 2016/0284252 A1
(43) Pub. Date: Sep. 29, 2016

(54) CARRIER SYSTEM WITH ELECTRICAL AND ELECTRONIC ELEMENTS AND CONNECTIONS FOR URBAN USE

(71) Applicant: Juan SADABA FERNANDEZ, Bilbao - Vizcaya (ES)

(72) Inventor: Juan SADABA FERNANDEZ, Vizcaya (ES)

(21) Appl. No.: 15/033,125

(22) PCT Filed: Nov. 13, 2013
(86) PCT No.: PCT/ES2013/070796

§ 371 Date: Apr. 29, 2016

(51) Int. Cl. G09F 15/00; F21V 21/00; H02J 7/00

(52) U.S. Cl. CPC G09F 15/0037; H02J 7/0027; F21V 21/00

(57) ABSTRACT

The invention relates to a carrier system with electrical and electronic elements and connections for urban use, including a base unit (1) which contains a built-in electrical plate (4) and a CPU unit (5), connected to an electric power supply, for the connection of service function device (7) located in external couplings (8), the base unit (1) also including a coupling (9) for optionally mounting a post (10) which, in turn, carries service functions.

### CROSS REFERENCE TO RELATED APPLICATION

This application is a national stage entry of PCT/ES2013/070796 filed Nov. 13, 2013, under the International Convention.

### TECHNICAL FIELD

The present invention relates to street furniture elements that are provided for fulfilling public service functions, such as illumination, advertising or information presentations, connectivity for charging electrical apparatus or for transmission of communications, etc., proposing a carrier system which allows providing as a whole a service consisting of all those service functions in one and the same street furniture element, with the possibility of selectively establishing combinations thereof.

### PRIOR ART

Street furniture elements incorporating public service functions, such as street lights, advertising or sign boards, connection posts for electrical charging or communications, etc., are in general functionally-independent structural elements.

However, said elements tend to have a similar structural formation for different applications when they are intended for one and the same area of placement, requiring in many cases positioning several elements for different functions in one and the same place, with the drawbacks of installation, taking up space and being an obstacle in the sites of application that it entails.

Elements of this type usually also have a rigid structural formation, such that they do not allow adaptation thereof for different arrangements of application, requiring the production of different elements for each arrangement of application.

### SUMMARY OF THE INVENTION

The invention proposes a carrier system with connections and elements for establishing public service functions by means of a street furniture-type support, in which different functional combinations can be selectively established.

This system object of the invention comprises a base unit formed by a hollow casing provided with an opening for access to the interior which is closed with a cover and anchoring means for fixing to the ground, there being a built-in electrical plate and a CPU unit, in relation with a data and electric power supply, for the connection of service function means located in the couplings of the casing, which also establishes a coupling for mounting a post carrying service functions located in elevation.

A system is thereby obtained, the base unit of which can itself be used as an element for placement of illuminating means, acoustic means, means for human detection, electric charging means, wireless communication means, etc., said base unit also being able to be complemented with a post for placement of functional means such as those indicated and others such as advertising and information supports, all this in an assembly based on one and then same installation element.

There is envisaged for coupling on the base unit a modular post solution formed by sections that can be attached successively to one another to form a selective composition, having sections of different configurations to establish different functions of application.

Based on the foregoing, this system object of the invention has features making it advantageous for its intended application, acquiring own identity and preferred character with respect to the conventional elements that are used for providing public service functions by means of street furniture.

### DESCRIPTION OF THE DRAWINGS

FIG. 1 shows an external schematic view of the base unit of the system object of the invention, according to one embodiment;

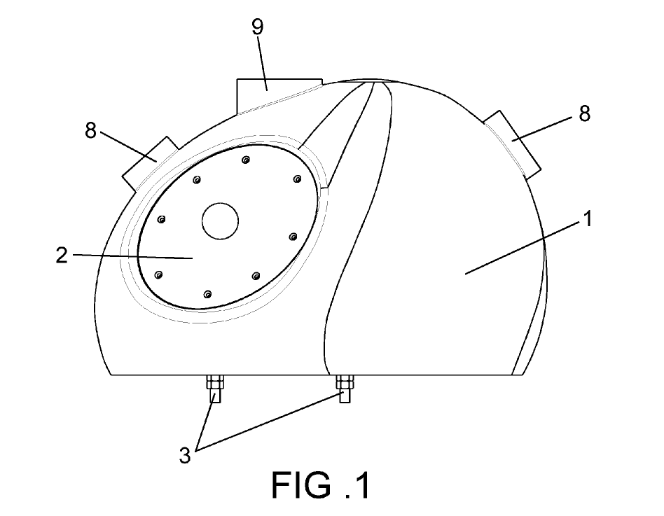

FIG. 2 is a sectioned schematic view of said base unit of the system of the invention; and

FIG. 3 is a schematic view of a composition of the system of the invention with a post modular coupled on the base unit.

### DETAILED DESCRIPTION OF THE INVENTION

The object of the invention relates to a carrier system with connections and elements for establishing public service functions in a street furniture element, comprising a base unit (1) formed by a hollow casing provided with a cover (2) closing an opening for access to the interior, having anchoring means (3) for fixing to the ground.

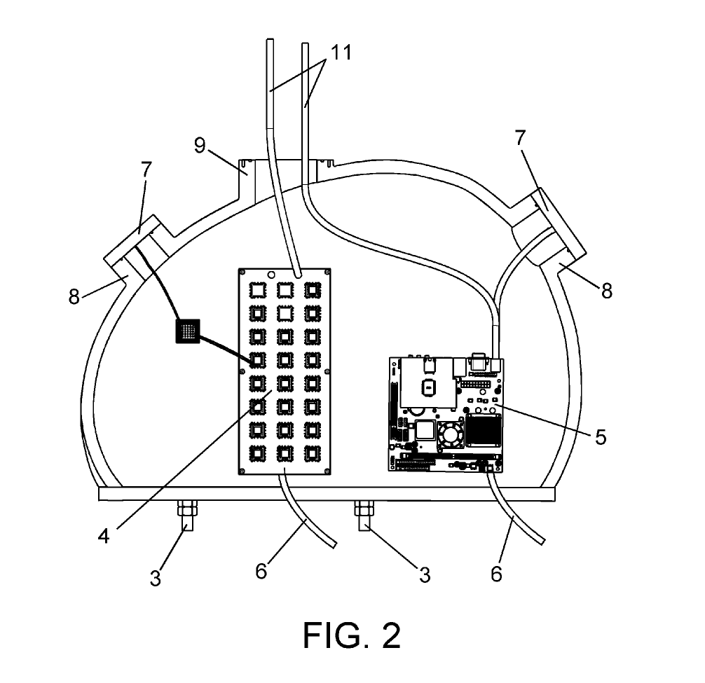

As seen in FIG. 2, said base unit (1) incorporates a built-in electrical plate (4) and a CPU unit (5), in connection with data and electric power supply cablings (6), for the connection of service function means (7) located in external couplings (8), for example, illuminating means, sound-emitting means, human presence sensing means, electric charging means (for electric cars, mobile telephones or other electronic apparatus), wireless communication means for data transmission-reception, etc.

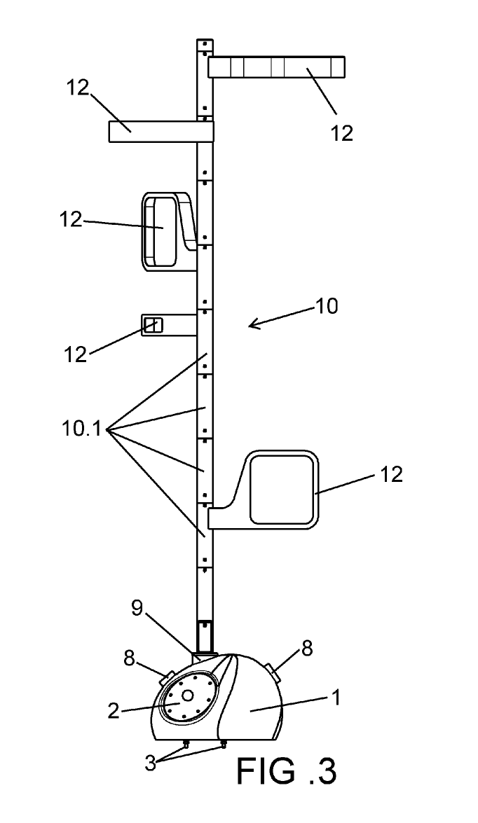

The base unit (1) also includes a coupling (9) for the optional mounting, as seen in FIG. 3, of a post (10) carrying service functions, which are in turn connected by means of cables (11) arranged inside the post (10), with the electrical plate (4) and the CPU unit (5) of the base unit (1) which, in this case, acts as a base for holding the post (10) and as a core for supplying electric power and controlling the functions incorporated therein.

For the incorporation in relation with the base unit (1) there is envisaged a modular post (10) which can have a selective composition by means of consecutive sections (10.1), which can establish configurations (12) for different service functions, such as illumination street lights, advertising or dynamic information banners, data or electrical connection plugs, sound emitting modules, etc.

The system is therefore of application using only the base unit (1) as means for placement of different service functions in a single street furniture element; said base unit (1) optionally being able to be complemented with a configurable post (10) in which the same or other service functions can be incorporated in an elevated arrangement, with a selective distribution thereof in the assembly of application.

The base unit (1) can in turn have variable shapes and dimensions, being able to adopt any regular or irregular geometric configuration or non-geometric configurations with any striking or aesthetically-pleasing appearance in relation with the places of application.

1. A carrier system with electrical and electronic elements and connections for urban use, for the incorporation of public service functions in a street furniture element comprising:
a base unit (1) formed by a hollow casing with anchoring means (3) for fixing to the ground, said base unit (1) incorporating a built-in electrical plate (4) and a CPU unit (5), in connection with data and electric power supply cablings (6), for the connection of service function means (7) located in external couplings (8); the base unit (1) also including a coupling (9) for optionally mounting a post (10) which in turn carries service functions.

2. The carrier system with electrical and electronic elements and connections for urban use according to claim 1, wherein the service functions which are incorporated in the optional post (10) connect with the electrical plate (4) and the CPU unit (5) of the base unit (1) by means of cables (11) that are arranged inside the post (10).

3. The carrier system with electrical and electronic elements and connections for urban use according to claim 1, wherein the optional post (10) is formed by a modular composition by means of consecutive sections (10.1) which establish configurations (12) for different service functions.

4. The carrier system with electrical and electronic elements and connections for urban use according to claim 1, wherein the service functions which are incorporated in the base unit (1) or in the optional post (10) comprise illuminating means.

5. The carrier system with electrical and electronic elements and connections for urban use according to claim 1, wherein the service functions which are incorporated in the base unit (1) or in the optional post (10) comprise advertising or dynamic information medium.

6. The carrier system with electrical and electronic elements and connections for urban use according to claim 1, wherein the service functions which are incorporated in the base unit (1) or in the optional post (10) comprise sound-emitting means.

7. The carrier system with electrical and electronic elements and connections for urban use according to claim 1, wherein the service functions which are incorporated in the base unit (1) or in the optional post (10) comprise human presence sensing means.

8. The carrier system with electrical and electronic elements and connections for urban use according to claim 1, wherein the service functions which are incorporated in the base unit (1) or in the optional post (10) comprise electric charging means.

9. The carrier system with electrical and electronic elements and connections for urban use according to claim 1, wherein the service functions which are incorporated in the base unit (1) or in the optional post (10) comprise wireless communication means for data transmission-reception.
